(19) United States
(12) Patent Application Publication
(10) Pub. No.: US 2012/0200604 A1
(43) Pub. Date: Aug. 9, 2012

(54) MAP DISPLAY DEVICE, MAP DISPLAY METHOD AND MAP DISPLAY PROGRAM

(75) Inventors: Yoichi Imaeda, Meguro (JP); Fukutarou Kikuchi, Kawasaki (JP)

(73) Assignees: INCREMENT P CORPORATION, Kanagawa (JP); PIONEER CORPORATION, Kanagawa (JP)

(21) Appl. No.: 13/500,204

(22) PCT Filed: Oct. 16, 2009
(86) PCT No.: PCT/JP2009/067897

§ 371 Date: Apr. 4, 2012

(51) Int. Cl. G06T 3/60

(52) U.S. Cl. 345/650

(57) ABSTRACT

The map display device may be a mobile terminal device, and a map is displayed on the display unit. The display unit may be a liquid crystal display device of touch-panel type, and detects the contact position of the contact body such as a user's finger, a touch pen or else. When plural contact bodies contact the display unit, the display mode is changed from the normal display mode to the map rotation mode based on the movement amounts of the contact bodies. In the map rotation mode, the displayed map is rotated and displayed based on the movement amount of the contact position of the contact body. When only one contact body is in contact with the display unit after the change to the map rotation mode, the displayed map is rotated and displayed based on the movement amount of the contact position of the one contact body.

### TECHNICAL FIELD

The present invention relates to a technique of rotating a map displayed on a display device.

### BACKGROUND TECHNIQUE

There is known a function of displaying a map on a mobile terminal device such as a mobile phone. For example, in a mobile terminal device having a GPS (Global Positioning System), it is possible to display a map around a current position on a display unit. In this case, a user wants to rotate the displayed map in consideration of his or her moving direction.

Patent references 1 and 2 disclose a method of rotating the map displayed on a display device. In Patent reference 1, a user rotates the displayed map by touching a touch-panel type display unit by two fingers and rotating the two fingers. Similarly, in Patent reference 2, the displayed map is rotated by touching the touch-panel type display unit by two or more fingers and rotating those fingers.

### PRIOR ART REFERENCES

### Patent References

Patent Reference 1:

US Patent Publication US2006/0026521 (See. [0109], FIGS. 15A to 15C)
Patent Reference 2:

Japanese Patent Application Laid-open under No. 2008-158842

### SUMMARY OF INVENTION

### Problem To Be Solved By the Invention

However, in the above-mentioned Patent references 1 and 2, when the rotation angle of the map is large, the rotation operation becomes difficult due to the structure of a wrist of a human being. Namely, in order to rotate two or more fingers more than 180 degrees with keeping the contact with the display unit, the user needs to rotate the wrist and/or move the elbow. Thus, the smooth rotation operation becomes difficult.

The above is one of the problems to be solved by the present invention. It is an object of the present invention to provide a map display device capable of easily rotate the displayed map even if the desired rotation angle is large.

### Means For Solving the Problem

The invention of claim 1 is a map display device including: a map display unit which displays a map on a display unit; a contact detecting unit which detects a contact position of a contact body with the display unit; a mode changing unit which changes a display mode by the map display unit from a normal display mode to a map rotation mode based on a movement amount of the contact positions of plural contact bodies; a map rotating unit which rotates the displayed map based on the movement amount of the contact position of the contact body, wherein, when only one contact body is in contact with the display unit after the change to the map rotation mode, the map rotating unit rotates the displayed map based on the movement amount of the contact position of the one contact body.

The invention of claim 6 is a map display method executed by a map display device including a display unit, including: a map display process which displays a map on the display unit; a contact detecting process which detects a contact position of a contact body with the display unit; a mode changing process which changes a display mode by the map display unit from a normal display mode to a map rotation mode based on a movement amount of the contact positions of plural contact bodies; a map rotating process which rotates the displayed map based on the movement amount of the contact position of the contact body, wherein, when only one contact body is in contact with the display unit after the change to the map rotation mode, the map rotating process rotates the displayed map based on the movement amount of the contact position of the one contact body.

The invention of claim 7 is a map display program executed by a map display device including a display unit and a computer, the program makes the computer function as: a map display unit which displays a map on the display unit; a contact detecting unit which detects a contact position of a contact body with the display unit; a mode changing unit which changes a display mode by the map display unit from a normal display mode to a map rotation mode based on a movement amount of the contact positions of plural contact bodies; a map rotating unit which rotates the displayed map based on the movement amount of the contact position of the contact body, wherein, when only one contact body is in contact with the display unit after the change to the map rotation mode, the map rotating unit rotates the displayed map based on the movement amount of the contact position of the one contact body.

### BRIEF DESCRIPTION OF THE DRAWINGS

FIG. 1 shows an appearance of a mobile terminal device according to an embodiment of a map display device of the present invention.

FIG. 2 is a block diagram showing a functional configuration of the mobile terminal device.

FIGS. 3A to 3C show examples of map rotation operation using two fingers.

FIGS. 4A and 4B show examples of map rotation using one finger.

FIG. 5 is a flowchart of map rotation process.

FIGS. 6A to 6C are diagrams for explaining a rotation reference point in a modified example.

### PREFERRED FORM TO EXERCISE THE INVENTION

According to one aspect of the present invention, there is provided a map display device including: a map display unit which displays a map on a display unit; a contact detecting unit which detects a contact position of a contact body with the display unit; a mode changing unit which changes a display mode by the map display unit from a normal display mode to a map rotation mode based on a movement amount of the contact positions of plural contact bodies; a map rotating unit which rotates the displayed map based on the movement amount of the contact position of the contact body, wherein, when only one contact body is in contact with the display unit after the change to the map rotation mode, the map rotating unit rotates the displayed map based on the movement amount of the contact position of the one contact body.

The above-mentioned map display device may be a mobile terminal device, for example. A map is displayed on the display unit. The display unit may be a liquid crystal display device of touch-panel type, for example, and detects the contact position of the contact body such as a finger of the user, a touch pen or else. When plural contact bodies contact the display unit, the display mode is changed from the normal display mode to the map rotation mode based on the movement amounts of the contact bodies. In the map rotation mode, the displayed map is rotated and displayed based on the movement amount of the contact position of the contact body. When only one contact body is in contact with the display unit after the change to the map rotation mode, the displayed map is rotated and displayed based on the movement amount of the contact position of the one contact body.

Therefore, once the display mode is changed to the map rotation mode, the user can rotate the map by the rotation operation using only one finger, for example. Thus, the user can easily rotate the map even if the desired rotation angle is large.

According to one mode of the above map display device, the map rotation unit rotates the map around a rotation reference point as a center, and, when only one contact body is in contact with the display unit after the change to the map rotation mode, the map rotation unit determines a rotation amount of the map based on the movement amount of the contact position of the one contact body with respect to the rotation reference point. In this mode, when only one contact body is in contact with the display unit, the rotation amount of the map is determined based on the rotation reference point and the contact position of the one contact body.

In a preferred example, the rotation reference point is a center point of the contact positions where two contact bodies first contact the display unit. In this case, the user can set the center of the rotation to an arbitrary position by changing the position where two contact bodies first contact the display unit. In another preferred example, the rotation reference point is a center of the map displayed on the display unit.

According to another mode of the above map display device, the mode changing unit continues the map rotation mode, after the change to the map rotation mode, as long as at least one contact body is in contact with the display unit. In this mode, once the display mode is changed to the map rotation mode, the user can continue the rotation of the map by using two fingers or using only one finger. In addition, it is possible to switch the operation using two fingers and the operation using only one finger.

According to another aspect of the present invention, there is provided a map display method executed by a map display device including a display unit, including: a map display process which displays a map on the display unit; a contact detecting process which detects a contact position of a contact body with the display unit; a mode changing process which changes a display mode by the map display unit from a normal display mode to a map rotation mode based on a movement amount of the contact positions of plural contact bodies; a map rotating process which rotates the displayed map based on the movement amount of the contact position of the contact body, wherein, when only one contact body is in contact with the display unit after the change to the map rotation mode, the map rotating process rotates the displayed map based on the movement amount of the contact position of the one contact body.

By the above map display method, once the display mode is changed to the map rotation mode, the user can rotate the map by the rotation operation using only one finger, for example. Therefore, the user can easily rotate the map even if the desired rotation angle is large.

According to still another aspect of the present invention, there is provided a map display program executed by a map display device including a display unit and a computer, the program makes the computer function as: a map display unit which displays a map on the display unit; a contact detecting unit which detects a contact position of a contact body with the display unit; a mode changing unit which changes a display mode by the map display unit from a normal display mode to a map rotation mode based on a movement amount of the contact positions of plural contact bodies; a map rotating unit which rotates the displayed map based on the movement amount of the contact position of the contact body, wherein, when only one contact body is in contact with the display unit after the change to the map rotation mode, the map rotating unit rotates the displayed map based on the movement amount of the contact position of the one contact body.

By implementing the above map display program on a computer, the map display device according to the invention can be realized.

### Embodiment

A preferred embodiment of the present invention will be described below with reference to the attached drawings.

### Device Configuration

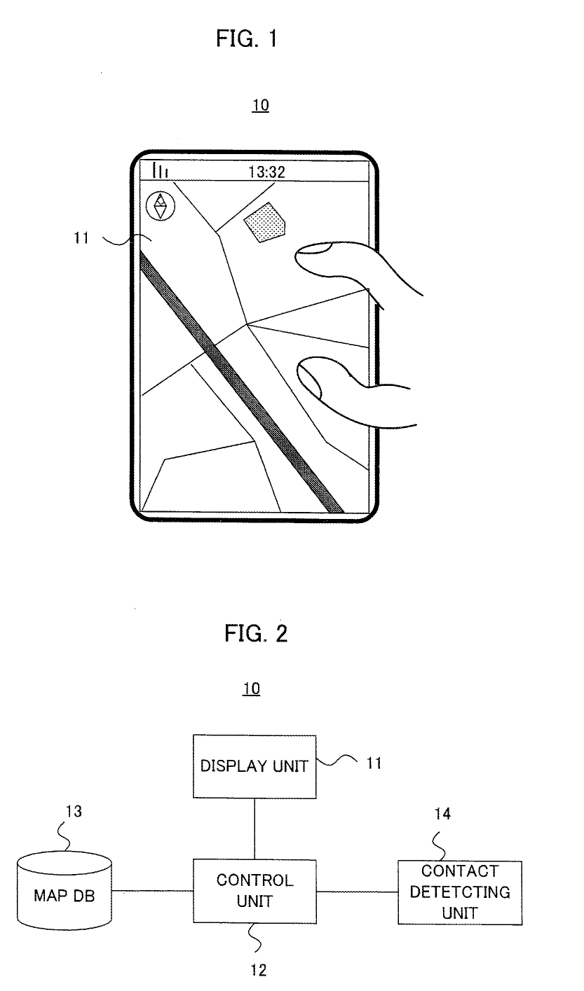

FIG. 1 shows an appearance of a mobile terminal device (hereinafter simply referred as “terminal device”) according to an embodiment of a map display device of the present invention. The terminal device 10 has a touch-panel type display unit 11. In the present invention, the method of the touch panel is not limited if the touch (contact) position on the display unit 11 can be detected. As shown in FIG. 1, a map is displayed on the display unit 11.

The user can change the map display state by touching the display unit 11 with fingers or else. For example, by moving a finger in contact with the display unit 11, the map can be scrolled. By touching the display unit 11 by two fingers and rotating the fingers in a clockwise or counterclockwise direction, the displayed map can be rotated. The map rotating method will be described later in detail.

FIG. 2 shows a functional configuration of the terminal device 10. FIG. 2 shows only the configuration related to the map rotation process by the present invention, and the configuration related to other general function of the terminal device 10 is omitted.

As illustrated, the terminal device 10 includes the above-mentioned display unit 11, a control unit 12, a map database (DB) 13 and a contact detecting unit 14.

The control unit 12 executes a process for rotating the map to be displayed on the display unit 11. The control unit 12 is configured by a CPU and the like, and executes the above process by implementing a program prepared in advance. The control unit 12 corresponds to a map display unit, a mode changing unit and a map rotating unit of the present invention.

The map DB 13 is a storage medium which stores map data, and may be a flash memory in this embodiment. The contact detecting unit 14 is a sensor mechanism provided on the touch-panel type display unit 11, and detects the presence/absence and the contact position of a contact body against the display unit 11 on which the map is displayed. The contact body is not limited to a finger of human being, and may be a touch pen or the like other than the fingers. The contact detecting unit 14 corresponds to the contact detecting unit of the present invention.

### Map Rotating Method

Next, the map rotating method will be described. In this embodiment, the user touches the display unit 11 by two fingers, and performs the operation of rotating the map (hereinafter referred to as “rotation operation”) by rotating those two fingers in a desired direction.

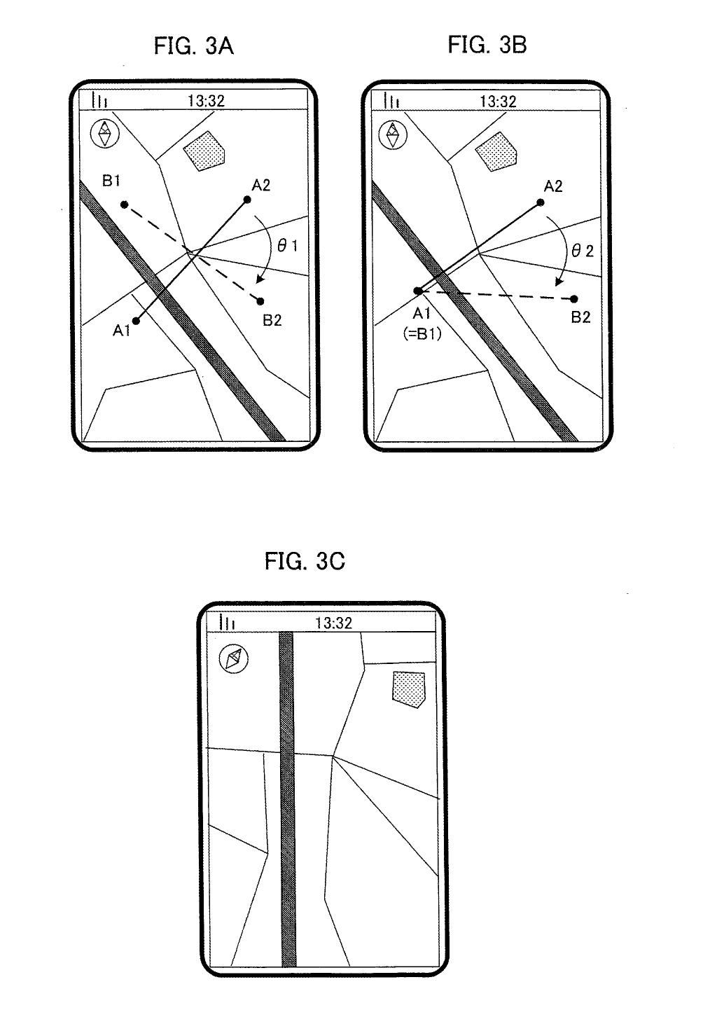

FIG. 3A shows an example of the rotation operation. First, the user touches the display unit 11 by two fingers. The contact points A1 and A2 show the contact positions where the two fingers of the user first contacts the display unit 11 for a single rotation operation. The solid line A1A2 is a line segment connecting the contact points A1 and A2, which is a base for determining the rotation amount of the map (hereinafter referred to as “base line segment”).

Next, the user rotates the two fingers with keeping the contact with the display unit 11. When the user rotates the two fingers by the angle θ1, the two fingers are in contact with the display unit 11 at the contact points B1 and B2, respectively, after the rotation operation. The broken line B1B2 is a line segment connecting the contact points B1 and B2 after the rotation operation (hereinafter referred to as “rotated line segment”). In this case, the rotation amount θ1 of the rotation operation by the user is the angle formed by the base line segment A1A2 and the rotated line segment B1B2.

The control unit 12 changes the map display mode from a normal display mode to a map rotation mode when the rotation amount ν1 becomes equal to or larger than a base rotation amount θth. The normal display mode is a mode in which the map is simply displayed as shown in FIG. 1, which is different from the map rotation mode. The map rotation mode is a mode in which the map currently displayed is rotated based on the rotation operation by the user.

The base rotation amount θth is determined by the following equation, for example.

θth (rad)=A/L,

wherein L: distance between two contact points (=length of the base line segment A1A2), and A: a coefficient (e.g., “8”).

For example, assuming that the display unit 11 has a display area of 480 pixels in a vertical direction and 320 pixels in a horizontal direction, and that the length of the base line segment A1A2 is 200 pixels, the base rotation amount θth is obtained as follows.

Base rotation amount θth=8/200=0.04(rad)

Therefore, when the rotation amount θ1 becomes equal to or larger than 0.04(rad), the control unit 12 changes the display mode to the map rotation mode.

It is noted that the example of FIG. 3A shows the case where the user performs the rotation operation such that both the contact points A1 and A2 of the two fingers move. Instead, the user may perform the rotation operation by fixing one finger of the two fingers and rotating the other finger. FIG. 3B shows the example of such a case where one finger is fixed at the contact point A1 and the other finger is moved from the contact point A2 to B2 by the rotation amount θ2. Also in this case, the control unit 12 changes the display mode from the normal display mode to the map rotation mode when the rotation amount θ2 becomes equal to or larger than the base rotation amount θth.

In this embodiment, the user can scale up and down the displayed map by widening and narrowing the distance between the two fingers in contact with the display unit 11. This mode is called scale up/down mode. When the variation of the distance between the contact points of the two fingers detected by the contact detecting unit 14 becomes equal to or larger than a predetermined distance (e.g., 10 pixels), the control unit 12 changes the map display mode to the scale up/down mode.

When the map display mode changes to the map rotation mode, the control unit 12 rotates the map by the rotation amount θ1 or θ2 around the rotation reference point. Here, the rotation reference point is set to the center of the display area of the display unit 11, i.e., the center of the map being displayed. Therefore, the user can rotate the displayed map by a desired angle by rotating the two fingers by a desired angle while keeping the contact with the display unit 11.

Then, when the user releases the two fingers from the display unit 11, the contact detecting unit 14 detects it and the control unit 12 changes the map display mode from the map rotation mode to the normal display mode. As a result, as shown in FIG. 3C, the map at the time when the user releases the fingers from the display unit 11 is displayed on the display unit 11 in the normal display mode.

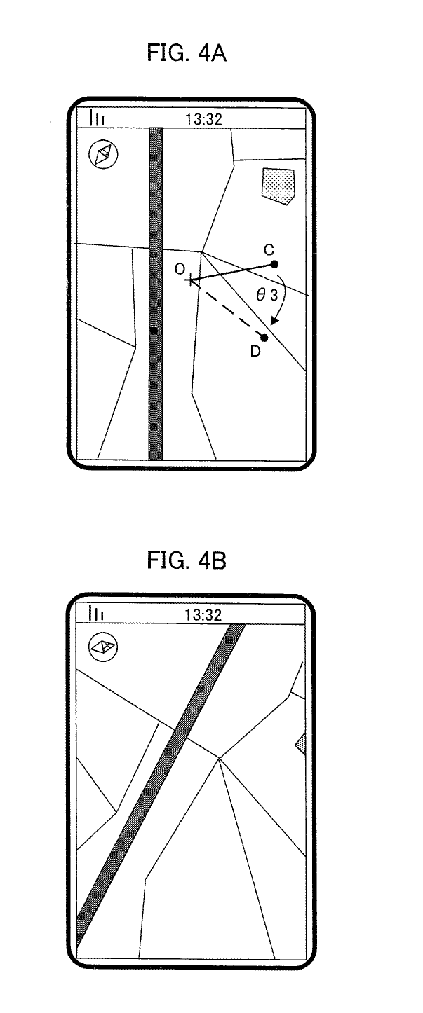

Further, in this embodiment, the user can continue the rotation operation by using only one finger after the display mode is changed to the map rotation mode. FIG. 4A shows an example of the rotation operation in this case. After entering the map rotation mode by rotating the positions of the two fingers, the user releases one finger from the display unit 11 and rotates only the other finger. In the example of FIG. 4A, it is assumed that the user moved the other finger in contact with the display unit 11 by the rotation amount θ3 from the contact point C to the contact point D. The contact detecting unit 14 detects that the fingers in contact with the display unit 11 is reduced to one finger and that the contact position of the finger moved from the contact point C to D, and notifies them to the control unit 12. When the control unit 12 knows that the fingers in contact with the display unit 11 is reduced to one finger, it determines the rotation amount of the map based on the rotation reference point O and the contact positions C and D of the one finger still in contact. Specifically, the control unit 12 determines, as the rotation angle, the angle θ3 between the line segment OC, formed by connecting the contact point C of the finger in contact when the fingers in contact with the display unit 11 is reduced to one with the rotation reference point O, and the ling segment OD, formed by connecting the contact point D of the finger after the movement with the rotation reference point O, and rotates the map by the rotation angle θ3.

Then, when the user releases the one finger from the display unit 11, the contact detecting unit 14 detects it, and the control unit 12 changes the map display mode from the map rotation mode to the normal display mode. As a result, as shown in FIG. 4B, the map at the time when the user releases the finger from the display unit 11 is displayed on the display unit 11 in the normal display mode.

As described above, in this embodiment, the user needs to perform the rotation operation by two fingers to enter the map rotation mode, but the user can perform the rotation operation by using only a single finger after entering the map rotation mode. The control unit 12 rotates the map by the rotation amount in accordance with the rotation operation by the single finger. Therefore, even if the desired rotation amount of the map is large, the user can easily perform the rotation operation by the single finger to rotate the map. In addition, since the rotation operation can be made by the single finger, the user can easily perform the rotation operation in the direction opposite to the direction in which the user first rotated the map. Namely, even when the user first rotated the map in a clockwise direction, the user can then rotate the single finger in contact with the display unit 11 in the counterclockwise direction to rotate the map in the opposite direction.

Further, once the control unit 12 enters the map rotation mode, it continues the map rotation mode, unless all the fingers are released from the display unit 11. Therefore, the user can arbitrarily switch between the rotation operation by two fingers and the rotation operation by a single finger, unless the user releases all the fingers from the display unit 11.

### Map Rotation Process

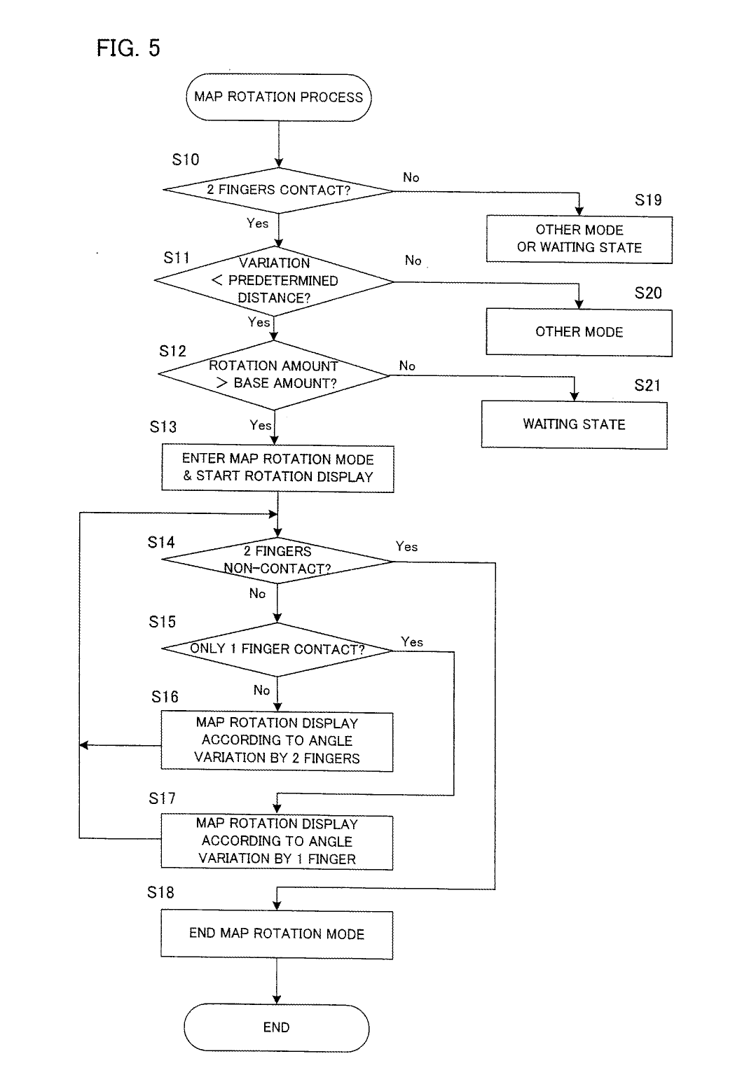

Next, the map rotation process will be described. FIG. 5 is a flowchart of the map rotation process according to this embodiment. This process is executed by the CPU or the like constituting the control unit 12, which implements the program prepared in advance.

In the state where the map is displayed on the display unit 11, the control unit 12 determines whether or not two fingers are in contact with the display unit 11, based on the output from the contact detecting unit 14 (step S10). If two fingers are not in contact (step S10; No), the control unit 12 executes the process of other mode or becomes the waiting state (step S19).

On the contrary, if two fingers are in contact with the display unit 11 (step S10; Yes), the control unit 12 determines whether or not the variation of the distance between two contact points is equal or smaller than the predetermined distance (step S11). In this embodiment, the predetermined distance is 10 pixels, for example, as described above. If the variation of the distance is larger than the predetermined distance (step S11; No), the control unit 12 executes the process of other mode such as the above-mentioned scale up/down mode (step S20). On the other hand, if the variation of the distance is equal to or smaller than the predetermined distance (step S11; Yes), the control unit 12 determines whether or not the rotation amount θ indicated by the rotation operation by the two fingers is equal to or larger than the base rotation amount θth (step S12). If the rotation amount θ is not equal to or larger than the base rotation angle θth (step S12; No), the control unit 12 goes to the waiting state (step S21). On the contrary, if the rotation amount θ is equal to or larger than the base rotation amount θth (step S12; Yes), the control unit 12 changes the map display mode to the map rotation mode, and starts the rotation display of the map (step S13).

Next, the control unit 12 determines whether or not both the two fingers are out of contact with the display unit 11, based on the output from the contact detecting unit 14 (step S14). If both the two fingers are not out of contact with the display unit 11 (step S14; No), the control unit further determines whether or not only one finger is in contact with the display unit 11 (step S15). If only one finger is not in contact with the display unit 11 (step S15; No), it means that two fingers are in contact with the display unit 11, and the control unit 12 rotates the map around the rotation reference point by the rotation amount θ in accordance with the rotation operation by those two fingers, as described with reference to FIGS. 3A and 3B (step S16).

On the contrary, if only one finger is in contact with the display unit 11 (step S15; Yes), the control unit 12 rotates the map around the rotation reference point by the rotation amount θ in accordance with the rotation operation by that one finger, as described with reference to FIG. 4A (step S17).

Then, in step S14, if both the two fingers are out of contact with the display unit 11 (step S14; Yes), i.e., when the user releases all the fingers from the display unit 11, the control unit 12 ends the map rotation mode (step S18). In this case, the control unit 12 displays the map, displayed at the time when the user releases all the fingers from the display unit 11, in the normal display mode.

As shown by the process of steps S14 to S17, this embodiment repeatedly detects whether the finger(s) in contact with the display unit 11 is one or two, and executes the rotation display in accordance with the number of the finger(s) in contact with the display unit 11 at that time. Therefore, once the map display mode enters the map rotation mode, the rotation of the map can be continued by a single finger or two fingers. For example, it is possible to perform the rotation operation by one of two fingers, then make both the two fingers contact, and further continue the rotation operation only by the other one of the two fingers.

### Modified Examples

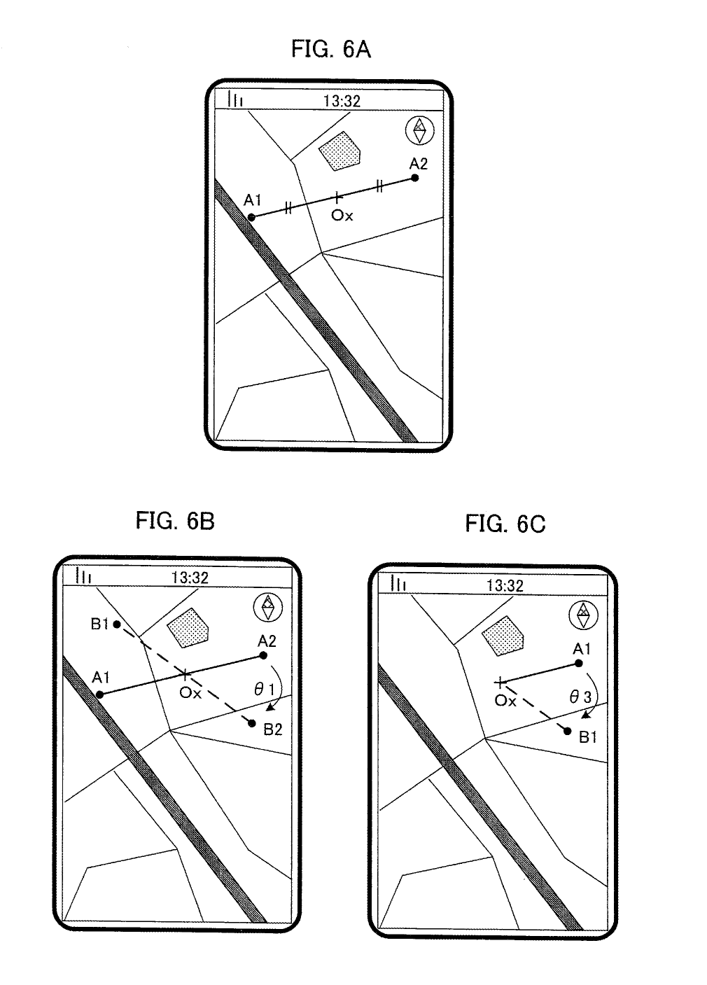

In the above embodiment, the control unit 12 sets the rotation reference point to the center of the display unit 11, i.e., the center of the displayed map. Instead, the control unit 12 may determine the rotation reference point based on the positions where the user first makes two fingers contact the display unit 11. This method will be described with reference to FIG. 6.

In FIG. 6A, it is assumed that the user puts two fingers at the contact points A1 and A2 to make contact with the display unit 11. The control unit 12 determines the center point Ox of the contact points A1 and A2 as the rotation reference point. Then, as shown in FIGS. 6B and 6C, the control unit 12 rotates the map by the rotation amount θ1 or θ3 around the rotation reference point Ox as the center. By this method, the user can rotate the map around an arbitrary point in the displayed map as the center.

While the control unit 12 enters the map rotation mode when it detects that two fingers contact the display unit 11 in the above embodiment, the control unit may enter the map rotation mode when it detects that more than two fingers contact the display unit 11. In that case, the rotation amount may be calculated for the combinations of two contact points out of three contact points. Then, the control unit 12 may enter the map rotation mode if one of them becomes equal to or larger than the base rotation amount θth, or if all of them become equal to or larger than the base rotation amount θth.

While the present invention is applied to the mobile terminal device in the above embodiment, the present invention is not limited to this. The present invention may be applied to various kinds of map display devices using a display device having a contact detecting function such as a touch-panel system.

In the above embodiment, when all the fingers are released from the display unit 11, the map rotation mode ends and the map being displayed at that time is displayed. Instead, when the map rotation mode ends, the map being displayed before entering the map rotation mode, i.e., the map being displayed at the time when the user first makes two fingers contact the display unit 11 may be displayed.

### INDUSTRIAL APPLICABILITY

This invention can be used for a various devices capable of displaying map, such as a mobile terminal device including a mobile phone and a PDA (Personal Digital Assistant), a navigation device and a personal computer.

### DESCRIPTION OF REFERENCE NUMBERS

10 Mobile Terminal Device

11 Display Unit

12 Control Unit

13 Map Database (DB)

14 Contact Detecting Unit

1. A map display device comprising:
a map display unit which displays a map on a display unit;
a contact detecting unit which detects a contact position of a contact body with the display unit;
a mode changing unit which changes a display mode by the map display unit from a normal display mode to a map rotation mode based on a movement amount of the contact positions of plural contact bodies;
a map rotating unit which rotates the displayed map based on the movement amount of the contact position of the contact body,
wherein, when only one contact body is continuously in contact with the display unit after the map is rotated based on the movement amount of the plural contact bodies in the map rotation mode, the map rotating unit rotates the displayed map based on the movement amount of the contact position of the one contact body.

2. The map display device according to claim 1,
wherein the map rotation unit rotates the map around a rotation reference point as a center, and
wherein, when only one contact body is in contact with the display unit after the change to the map rotation mode, the map rotation unit determines a rotation amount of the map based on the movement amount of the contact position of the one contact body with respect to the rotation reference point.

3. The map display device according to claim 2, wherein the rotation reference point is a center point of the contact positions where two contact bodies first contact the display unit.

4. The map display device according to claim 2, wherein the rotation reference point is a center of the map displayed on the display unit.

5. The map display device according to claim 1, wherein the mode changing unit continues the map rotation mode, after the change to the map rotation mode, as long as at least one contact body is in contact with the display unit.

6. A map display method executed by a map display device including a display unit, comprising:
a map display process which displays a map on the display unit;
a contact detecting process which detects a contact position of a contact body with the display unit;
a mode changing process which changes a display mode by the map display unit from a normal display mode to a map rotation mode based on a movement amount of the contact positions of plural contact bodies;
a map rotating process which rotates the displayed map based on the movement amount of the contact position of the contact body,
wherein, when only one contact body is continuously in contact with the display unit after the map is rotated based on the movement amount of the plural contact bodies in the map rotation mode, the map rotating process rotates the displayed map based on the movement amount of the contact position of the one contact body.

7. A map display program stored on a non-transitory storage medium and executed by a map display device including a display unit and a computer, the program makes the computer function as:
a map display unit which displays a map on the display unit;
a contact detecting unit which detects a contact position of a contact body with the display unit;
a mode changing unit which changes a display mode by the map display unit from a normal display mode to a map rotation mode based on a movement amount of the contact positions of plural contact bodies;
a map rotating unit which rotates the displayed map based on the movement amount of the contact position of the contact body,
wherein, when only one contact body is continuously in contact with the display unit after the map is rotated based on the movement amount of the plural contact bodies in the map rotation mode, the map rotating unit rotates the displayed map based on the movement amount of the contact position of the one contact body.

8. (canceled)
